(19) United States
(12) Patent Application Publication
(10) Pub. No.: US 2003/0164945 A1
(43) Pub. Date: Sep. 4, 2003

(54) Image comparator

(75) Inventor: Wen-Tsao Lee, Hsinchu (TW)

Correspondence Address: WEN-TSAO LEE, NO. 10-17, SHIAUFENLIN, DALIN TSUEN, BEI PU, HSINCHU, 314, TW

(73) Assignee: Mr. Wen-Tsao Lee, Hsinchu (TW)

(21) Appl. No.: 09/683,924

(22) Filed: Mar. 3, 2002

(51) Int. Cl. G01B 9/08

(52) U.S. Cl. 356/393

(57) ABSTRACT

The present invention relates to a comparator of image. In a preferred aspect, the comparator of the invention includes an electronic image display, which shows a picture image for reference, a splitter mirror with a mirror forming an optical path, and making comparison between reference image and image of pattern selected, both images are projected to the same optical plan on the optical path, through overlapping process to achieve precise comparison.

### BACKGROUND OF INVENTION

This invention relates to a comparator of image in the field of optical instruments. This image comparator includes an electronic image display, which shows a picture image for reference, a splitter mirror with a mirror forming an optical path, and making comparison between reference image and image of pattern selected, both images are projected to the same optical plan on the optical path, through overlapping process to achieve precise comparison. It is well known in the art that patterns comparison based on the method of superimposing, it can do for the pattern of simple and non-precise, but for the pattern of complicated such as printed circuit layout or image picture.

### SUMMARY OF INVENTION

The concept of this invention is based upon the character of splitter mirror, making partial penetration and reflection of the image, with mirror to form an optical path. Through this optical path, a reference image, and one image of pattern chosen for comparison, both images are projected to a splitter mirror, respectively, at a 45-degree angle of incidence. By way of, a splitter mirror set up in the optical path, two images within the equal optical distance to the splitter mirror, appears on the same optical plan is observable. An electronic image display provides the reference image, and such image is captured in advance by an electronic image scanning device such as an electronic camera or scanner for converting scanned light signal of a reference image into electronic digital signal, and then storing the digital signal into computer memory after computer processing, and using the fast searching ability of the computer to search for the required data and process the image by enlarging, reducing, mirroring, and rotating the image, etc., and the processed high resolution digital video signal is outputted to the high-resolution electronic display such as liquid crystal display (LCD), plasma display (P D), field emission display (FED), organic light emission display (OLED) etc. that provides accurate and clear reference image. Adjustment on the corresponding position between reference image and the targeted one for comparison is done so that the two images are overlapped one on the other. If it is a perfect match, there will be only a sole image presented. If the two images are inconsistent, the targeted pattern is then interpreted as not same as the original pattern.

### Brief Description of Drawings

FIG. 1 is a schematic view showing a single pattern comparison structure.

FIG. 2 is a schematic view showing another single pattern comparison structure.

FIG. 3 is a schematic view showing a single pattern multiple-order magnification comparison structure.

FIG. 4 is a schematic view showing a horizontal dual patterns comparison structure.

FIG. 5 is a schematic view showing a vertical dual patterns comparison structure.

FIG. 6 is a schematic view showing an adjustable magnification dual patterns comparison structure.

FIG. 7 is a schematic block diagram of an image display switching control unit.

### Detailed Description

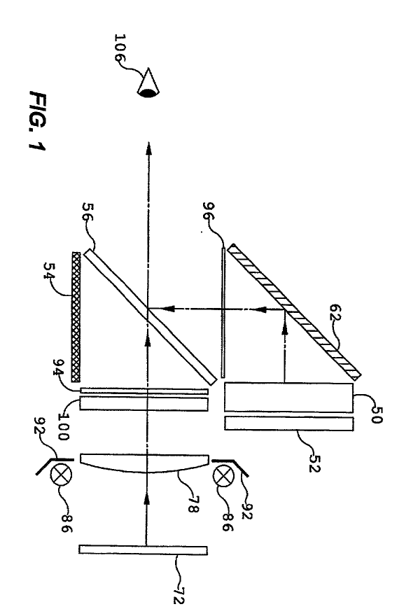

The detailed description of the preferred embodiments is as follows: As shown in FIG. 1, a electronic image display 50 is an electro-luminescence or illuminated by a backlight source 52, providing a high resolution reference image, such reference image goes to mirror 62, then being reflected from there goes through second polarizer 96, and then goes to splitter mirror 56, is the same as the optical distance of image of pattern 72 illuminated by light source 86 and reflection plate 92, whose image then goes through lens 78, liquid crystal panel 100, first polarizer 94, and then to splitter mirror 56.

Through splitter mirror 56 at an inclined angle of 45 degrees in the optical path, operator 106 is able to observe the reference image of electronic image display50 reflected off splitter mirror 56 as an erect virtual image after being mirrored twice, meanwhile, to see through splitter mirror 56 and observe both reference images of electronic image display50 and image of pattern72 presented on the same optical plane. After having the two images overlapped one on top of the other by adjusting corresponding position image of pattern72 with reference image, if they are consistent, it is the same pattern. If they are not, then it comes from a different pattern.

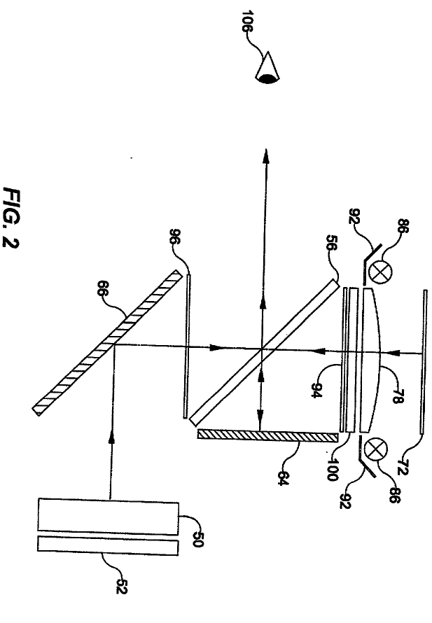

As shown in FIG. 2, reference image of electronic image display 50 goes to second mirror 66, then being reflected through second polarizer 96, then to splitter mirror 56, is the same as the optical distance of image of pattern 72 goes through lens 78, liquid crystal panel 100, first polarizer 94, to splitter mirror 56, then being reflected to first mirror 64, and then being reflected back to splitter mirror 50.

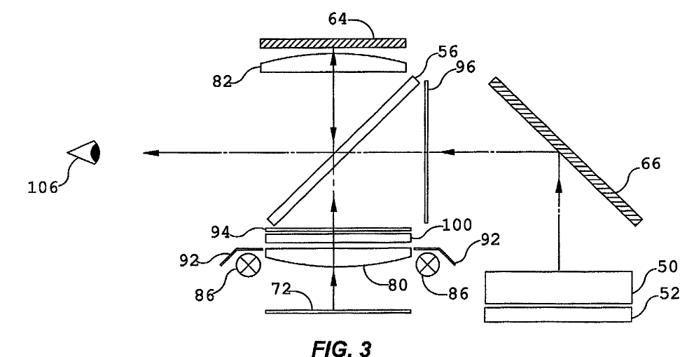

As shown in FIG. 3, reference image of electronic image display 50 goes to second mirror 66, then being reflected through second polarizer 96, then to splitter mirror 56, is the same as the optical distance of image of pattern 72 goes through first lens 80, liquid crystal panel 100, first polarizer 94, splitter mirror 56, second lens 82, then to first mirror 64, then being reflected back from there through second lens 82, then to splitter mirror 56.

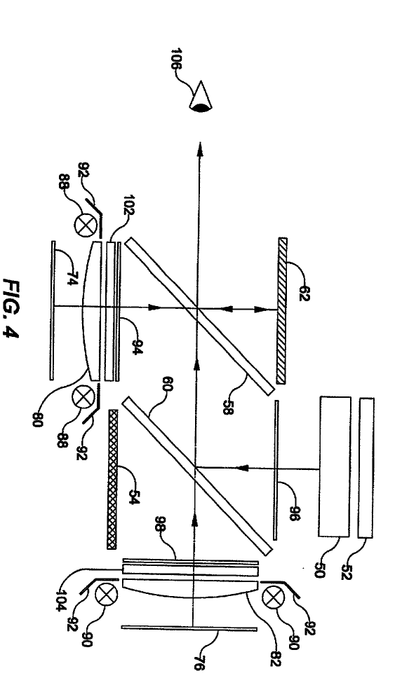

As shown in FIG. 4, reference image of electronic image display 50 goes through second polarizer 96, then to second splitter mirror 60, and then being reflected to first splitter mirror 58, is the same as the optical distance of image of first pattern 74 goes through first lens 80, first liquid crystal panel 102, first polarizer 94, first splitter mirror 58, then to mirror 62, and then being reflected back to first splitter mirror 58, is the same as the optical distance of image of second pattern 76 goes through second lens 82, second liquid crystal panel 104, third polarizer 98, second splitter mirror 60, then to first splitter mirror 58.

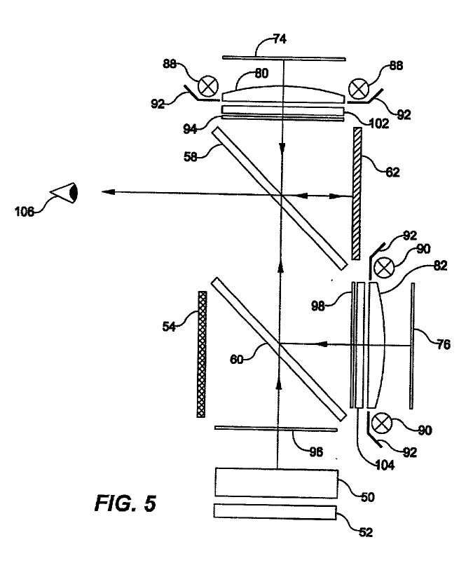

As shown in FIG. 5, reference image of electronic image display 50 goes through second polarizer 96, second splitter mirror 60, then to first splitter mirror 58, is the same as the optical distance of image of first pattern 74 goes through first lens 80, first liquid crystal panel 102, first polarizer 94, to first splitter mirror 58, then being reflected to mirror 62, and then being reflected back to first splitter mirror 58, is the same as the optical distance of image of second pattern 76 goes through second lens 82, second liquid crystal panel 104, third polarizer 98, then to second splitter mirror 60, and then being reflected to first splitter mirror 58.

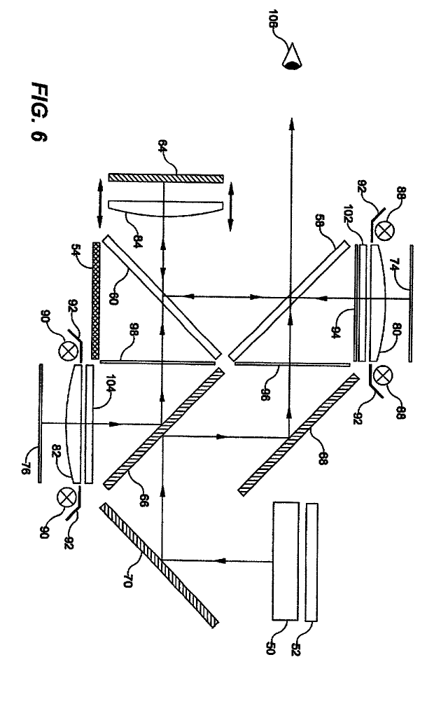

As shown in FIG. 6, reference image of electronic image display 50 goes to fourth mirror 70, then being reflected to second mirror 66, then being reflected to third mirror 68, then goes through second polarizer 96, and then to first splitter mirror 58, is the same as the optical distance of image of first pattern 74 goes through first lens 80, first liquid crystal panel 102, first polarizer 94, first splitter mirror 58, to second splitter mirror 60, then being reflected from there through third lens 84, then to first mirror 64, and then being reflected back from there through lens 84, then to second splitter mirror 60, and then being reflected to first splitter mirror 58, is the same as the optical distance of image of second pattern 76 goes through second lens 82, second liquid crystal panel 104, to second mirror 66, then being reflected from there through third polarizer 98, second splitter mirror 60, third lens 84, then to first mirror 64, and then being reflected back from there through lens 84, then to second splitter mirror 60, and then being reflected to first splitter mirror 58. Because the image of first pattern 74 and image of second pattern 76 go through the same optical distance, there is the same as the ratio of magnification between the image of first pattern 74 magnified through passing third lens 84 and the image of second pattern 76 magnified through passing third lens 84. Therefore, third lens 84 can be moved along the optical axis between first mirror 64 and second splitter mirror 60 to simultaneously increase and decrease the magnifying multiple of the images of first pattern 74 and second pattern 76.

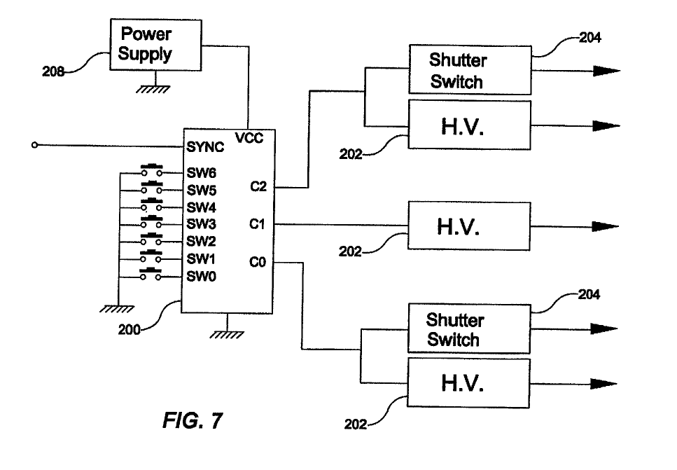

As shown in FIG. 7, an image display switching control unit, the detail as follows: High voltage circuit (H.V.) 202—Receiving from control signal sent from micro controller200, controls on/off status of high-voltage current, causing brightness/darkness of discharge tube of pattern light source; Liquid crystal shutter switch circuit (shutter switch) 204—Receiving from control signal sent from micro controller200, to activate the effect of electric field polarizing to control status of transparency or opaque of the liquid crystal panel with polarizer, dominating display of the image availability; Power Supply 208—providing electric power for image display switching control unit; Micro Controller200—a programmable central processing unit with ROM burned in relevant code based on a specific purpose, making the output signal status is controlled by input settings.

There are four different input settings of (1) controlling on/off status of first light source and light of electronic image display alternatively; (2) controlling on/off status of first light source and second light source and light of electronic image display alternatively;(3) controlling on/off status of first liquid crystal panel and light of reference image alternatively; (4)controlling on/off status of first liquid crystal panel and second liquid crystal panel and light of reference image alternatively.

When the movement comparison for an image of pattern is displayed alternatively, the frequency of each of such alternatively displayed varying electronic signals must be synchronous with the SYNC signal of the electronic display in order to avoid generating an incomplete and unstable image display, since the electronic display constitutes the image screen by scanning; the SYNC signal of a micro controller chip reference electronic display uses the reciprocal of the multiple of the SYNC cycles after the computation by the internal program to set several frequencies of the dynamic display that are synchronous with the SYNC signal for accomplishing the task.

In the optical path the direction of polarization between first polarizer94 and second polarizer96 is one against to the other but second polarizer96is same as third polarizer98 in the optical path, ensuring independent presentation of each image and avoiding mutual interference, therefore, to enhance the quality of images during comparison by reinforcing the contrast of each image. Furthermore, this is to cooperate with effect by first liquid crystal panel 102 and second liquid crystal panel 104, making alternating image display by controlling status of transparency or opaque of the optical path that determines the availability of image display.

The reference image displayed by the electronic image display after the enlargement process by computer operation, and the multiple of enlargement depend on the image of the compared image enlarged by the optical path. The light source for the patterns is determined by pattern format. Reflection light source is for opaque pattern, whereas, backlight is for transparent one. Reflection light source mainly relies on normal light bulbs. If fast transition between brightness and darkness is necessary, the reaction is sluggish. If equipped with liquid crystal panel and polarizer or switched to discharge lamp, then static and clear dynamic image is presented. Anti-reflection black board 54 is a light absorber for avoiding reflected optical noise in the optical path.

It will be now apparent to those skilled in the art that other embodiments, detail and uses can be made consistent with the letter and spirit of the foregoing disclosure and within the scope of this patent, which is limited only by the following claims, construed in accordance with the patent law, including the doctrine of equivalents.

1. An image comparator, comprising:
a) an electronic image display, which provides a reference image;
b) a first mirror, which making reflection of image;
c) a first light source, which illuminates first pattern for first image;
d) a first splitter mirror, which making partial penetration and reflection of image, with mirror to form an optical path, both reference image and image of pattern are projected to splitter mirror.

2. The image comparator in accordance with claim 1, wherein said reference image is captured in advance by an electronic image-scanning device to convert the reference video light signal into electronic digital signal and then store the digital signal into memory after computer processing, and the video signal is outputted from the computer to the electronic image display.

3. The image comparator in accordance with claim 1, wherein said first image goes to first splitter mirror, is the same as the optical distance of reference image goes to first mirror, then being reflected to first splitter mirror.

4. The image comparator in accordance with claim 1, further comprising a second mirror.

5. The image comparator in accordance with claim 4, wherein said reference image goes to second mirror, then being reflected to first splitter mirror, is the same as the optical distance of first image goes to first splitter mirror, then being reflected to first mirror, and then being reflected to first splitter mirror.

6. The image comparator in accordance with claim 1, wherein said reference image goes to first splitter mirror, is the same as the optical distance of first image goes through first splitter mirror, to first mirror, then being reflected to first splitter mirror.

7. The image comparator in accordance with claim 1, further comprising: a) a second splitter mirror; and b) a second light source, which illuminates second pattern for second image.

8. The image comparator in accordance with claim 7, wherein said reference image goes to second splitter mirror, then being reflected to first splitter mirror, is the same as the optical distance of first image goes through first splitter mirror, to first mirror, then being reflected to first splitter mirror, is the same as the optical distance of second image goes through second splitter mirror, to first splitter mirror.

9. The image comparator in accordance with claim 7, wherein said reference image goes through second splitter mirror, to first splitter mirror, is the same as the optical distance of first image goes to first splitter mirror, then being reflected to first mirror, then being reflected to first splitter mirror, is the same as the optical distance of second image goes to second splitter mirror, then being reflected to first splitter mirror.

10. The image comparator in accordance with claim 7, further comprising a second mirror and a lens.

11. The image comparator in accordance with claim 10, wherein said reference image goes to first splitter mirror, is the same as the optical distance of first image goes through first splitter mirror, to second splitter mirror, then being reflected from there goes through lens, to first mirror and being reflected back to second splitter mirror, then being reflect to first splitter mirror, is the same as the optical distance of second image goes to second mirror, then being reflected from there goes through second splitter mirror and lens, to first mirror and being reflected back to second splitter mirror, then being reflect to first splitter mirror.

12. The image comparator in accordance with claim 11, wherein said lens moves along the optical axis between first mirror and second splitter mirror.

13. The image comparator in accordance with claim 3, 5 or 6 further comprising an image display switching control unit which having alternating electronic signal controlling on/off status of first light source and light of electronic image display alternatively.

14. The image comparator in accordance with claim 8, 9, or 11 further more comprising an image display switching control unit which having alternating electronic signal controlling on/off status of first light source and second light source and light of electronic image display alternatively.

15. The image comparator in accordance with claim 3, 5, or 6, further comprising: a) a first liquid crystal panel with a polarizer, which place between first pattern and splitter mirror; b) a polarizer, which place between electronic image display and first splitter mirror; c) an image display switching control unit, which having alternating electronic signal controlling on/off status of first liquid crystal panel and light of reference image alternatively.

16. The image comparator in accordance with claim 8, 9 or 11, further more comprising: a) a first liquid crystal panel with a polarizer, which place between first pattern and first splitter mirror; b) a second liquid crystal panel with a polarizer, which place between second pattern and second splitter mirror; c) a polarizer, which place between electronic image display and splitter mirror; d) an image display switching control unit, which having alternating electronic signal controlling on/off status of first liquid crystal panel and second liquid crystal panel and light of reference image alternatively.
